(19) United States
(12) Patent Application Publication
(10) Pub. No.: US 2025/0076579 A1
(43) Pub. Date: Mar. 6, 2025

(54) SYSTEMS, APPARATUSES, AND METHODS FOR FILM THICKNESS CONTROL FOR INTEGRATED PHOTONICS

(71) Applicant: Quantinuum LLC, Broomfield, CO (US)

(72) Inventors: Christopher T. Ertsgaard, Champlin, MN (US); Todd Michael Klein, Wayzata, MN (US); Christopher John Carron, Jefferson City, MO (US); Eugene Freeman, Plymouth, MN (US)

(21) Appl. No.: 18/824,331

(22) Filed: Sep. 4, 2024

Related U.S. Application Data
(60) Provisional application No. 63/580,834, filed on Sep. 6, 2023.

(51) Int. Cl. G02B 6/132; G02B 6/136; G21K 1/00

(52) U.S. Cl. CPC G02B 6/132; G02B 6/136; G21K 1/003

(57) ABSTRACT

Embodiments of the disclosure provide apparatuses, systems, and methods related to controlling film thickness in photonic-integrated apparatus. In some embodiments, a bottom cladding layer is deposited on a substrate, a thickness map of the bottom cladding layer is generated, thickness trimming is performed on the bottom cladding layer based on the thickness map for the bottom cladding layer; a waveguide core layer is deposited on the bottom cladding layer, a thickness map of the waveguide core layer is generated, thickness trimming is performed on the waveguide core layer based on the thickness map for the bottom waveguide core layer; a top cladding layer is deposited on the waveguide core layer, a thickness map of the top cladding layer is generated; and thickness trimming is performed on the top cladding layer based on the thickness map for the top cladding layer.

### CROSS REFERENCE TO RELATED APPLICATIONS

This application claims priority to U.S. Provisional Patent Application No. 63/580,834 filed on Sep. 6, 2023, which is incorporated herein by reference in its entirety.

### TECHNICAL FIELD

Various embodiments relate to apparatuses, systems, and methods relating to integrated photonics. An example embodiment relates to apparatuses, systems, and methods for film thickness control for photonic-integrated apparatus, for example, photonic-integrated confinement apparatus.

### BACKGROUND

In various contexts, integrating photonics in various systems and apparatus, such as an ion trap stack, provides the capability to scale up. Applicant has discovered problems associated with photonic-integrated confinement apparatus. Through applied effort, ingenuity, and innovation, Applicant has solved many of the identified problems by developing the embodiments of the present disclosure, many examples of which are described in detail below.

### BRIEF SUMMARY

In general, embodiments of the present disclosure herein provide for film thickness control for photonic-integrated apparatus, for example, photonic-integrated confinement apparatus. In accordance with one aspect of the present disclosure, an example method of controlling film thickness of a photonic-integrated confinement apparatus includes depositing a bottom cladding layer on a substrate; generating a thickness map of the bottom cladding layer; performing thickness trimming on the bottom cladding layer based on the thickness map for the bottom cladding layer, to achieve desired target thickness and thickness uniformity; depositing a waveguide core layer on the bottom cladding layer; generating a thickness map of the waveguide core layer; performing thickness trimming on the waveguide core layer based on the thickness map for the waveguide core layer, to achieve desired target thickness and thickness uniformity; depositing a top cladding layer on the waveguide core layer; generating a thickness map of the top cladding layer; and performing thickness trimming on the top cladding layer based on the thickness map for the top cladding layer, to achieve desired target thickness and thickness uniformity.

In some example embodiments, performing thickness trimming comprises performing one or more of ion beam trimming, fluid jet polishing, or magnetorheological polishing.

In some example embodiments, the bottom cladding layer is planarized prior to performing thickness trimming on the bottom cladding layer and/or after performing thickness trimming on the bottom cladding layer.

In some example embodiments, the bottom cladding layer is planarized by performing chemical mechanical polishing on the bottom cladding layer.

In some example embodiments, the waveguide core layer is mechanically polished prior to performing thickness trimming on the waveguide core layer and/or after performing thickness trimming on the waveguide core layer.

In some example embodiments, the top cladding layer is planarized prior to performing thickness trimming on the top cladding layer and/or after performing thickness trimming on the top cladding layer.

In some example embodiments, the top cladding layer is planarized by performing chemical mechanical polishing on the top cladding layer.

In some example embodiments, the method further includes patterning features within one or more of the bottom cladding layer or the top cladding layer, wherein the features comprise a plurality of metal layers.

In some example embodiments, the method further comprising performing thickness trimming on each metal layer of the plurality of metal layers based on a thickness map of the metal layer.

In some example embodiments, the photonic-integrated confinement apparatus comprises a multi-layered ion trap.

In accordance with another aspect of the present disclosure an example method of controlling film thickness of a photonic-integrated confinement apparatus includes depositing a bottom cladding layer on a substrate; generating a thickness map of the bottom cladding layer; performing thickness trimming on the bottom cladding layer based on the thickness map for the bottom cladding layer, to achieve desired target thickness and thickness uniformity; depositing a waveguide core layer on the bottom cladding layer; and depositing a top cladding layer on the waveguide core layer.

In accordance with another aspect of the present disclosure, photonic-integrated confinement apparatus is provided. In some example embodiments, the photonic-integrated confinement apparatus includes a bottom cladding layer formed on a substrate; a waveguide core layer formed on the bottom cladding layer; and a top cladding layer formed on the waveguide core layer; wherein thickness trimming was previously performed on one or more of the bottom cladding layer, the waveguide core layer, or the top cladding layer during fabrication of the photonic-integrated confinement apparatus, to achieve desired target thickness and thickness uniformity.

In some example embodiments, performing thickness trimming comprises performing one or more of ion beam trimming, fluid jet polishing, or magnetorheological polishing.

In some example embodiments, a plurality of metal layers are embedded within the bottom cladding layer and/or the top cladding layer; and thickness trimming was previously performed on one or more of the plurality of metal layers during fabrication of the photonic-integrated confinement apparatus, to achieve desired target thickness and thickness uniformity.

In some example embodiments, the photonic-integrated confinement apparatus comprises a multi-layered ion trap.

In accordance with another aspect of the present disclosure, photonic-integrated confinement apparatus system is provided. In some example embodiments, the example photonic-integrated confinement apparatus system includes a confinement apparatus chip comprising a photonic-integrated confinement apparatus having a bottom cladding layer, a waveguide core layer, and a top cladding layer thereon, wherein the waveguide core layer is sandwiched between the bottom cladding layer and the top cladding layer, and wherein thickness trimming was previously performed on one or more of the bottom cladding layer, the waveguide core layer, or the top cladding layer during fabrication, to achieve desired target thickness and thickness uniformity.

In some example embodiments, the photonic-integrated confinement apparatus system is configured for operation under cryogenic and/or vacuum conditions.

In some example embodiments, the example photonic-integrated confinement apparatus system, further includes a bridge chip having at least one optical element disposed thereon or a delivery chip having at least one delivery optical element disposed thereon, wherein thickness trimming is previously performed on one or more layers of the bridge chip or the delivery chip, to achieve desired target thickness and thickness uniformity.

In some example embodiments, a plurality of metal layers are embedded within the bottom cladding layer; and thickness trimming was previously performed on one or more of the plurality of metal layers during fabrication, to achieve desired target thickness and thickness uniformity.

In some example embodiments, the photonic-integrated confinement apparatus includes a multi-layered ion trap.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic diagram illustrating an example quantum computing system comprising a photonic-integrated confinement apparatus, according to an example embodiment.

FIG. 2 is a schematic cross-section view of a photonic-integrated confinement apparatus, according to an example embodiment.

FIG. 3 is a schematic cross-section view of another photonic-integrated confinement apparatus, according to an example embodiment.

FIG. 4 provides a flowchart illustrating various processes, procedures, and/or operations performed in fabricating a photonic-integrated confinement apparatus, according to an example embodiment.

FIG. 5 provides a schematic diagram of an example controller of a quantum computer configured to control operation of one or more photonic-integrated confinement apparatus, according to an example embodiment.

FIG. 6 provides a schematic diagram of an example computing entity of a quantum computer system that may be used in accordance with an example embodiment.

### DETAILED DESCRIPTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within engineering and/or manufacturing limits and/or within user measurement capabilities, unless otherwise indicated. Like numbers refer to like elements throughout.

Example embodiments provide apparatuses, systems, and methods that relate to photonic-integrated confinement apparatus and controlling film thickness in such photonic-integrated confinement apparatus, as well as other photonic-integrated apparatus that includes at least one film layer. In various embodiments, a photonic-integrated confinement apparatus system comprises a confinement apparatus configured for confining quantum objects and a signal management system, where at least a portion of the signal management system (e.g., at least one apparatus optical element) is disposed on the same substrate and/or chip as the electrical components (e.g., electrodes) of the confinement apparatus. The electrodes, for example, may be configured for defining confinement regions within which quantum objects may be confined. As used herein, the term apparatus optical element refers to an optical element formed and/or disposed on the confinement apparatus chip.

In various embodiments, the confinement apparatus chip further includes one or more optical elements that are disposed and/or formed thereon and/or therein. In various embodiments, the one or more optical elements are configured to provide respective optical manipulation signals to respective object locations defined within the confinement regions of the confinement apparatus and/or to receive/detect respective optical signals emitted by respective quantum objects located at respective object locations. In various embodiments, the one or more optical elements and/or the portion of the signal management system define at least one photonic layer of the confinement apparatus, where the photonic layer includes a waveguide for propagating photonic beams.

In various embodiments, the photonic-integrated confinement apparatus system is part of a system (e.g., quantum processor, quantum computer, and/or other atomic and/or quantum system) comprising a signal management system. For example, in various embodiments, a quantum system is provided comprising a confinement apparatus and a signal management system wherein one or more optical elements of the signal management system are formed and/or disposed on the confinement apparatus chip on which the confinement apparatus is formed and/or disposed. For example, the system may comprise a signal management system configured to generate, provide, control parameters of (e.g., wavelength, intensity, phase, polarization, and/or the like) of electromagnetic signals applied to one or more positions within the photonic-integrated confinement apparatus system for the purpose of controlling the quantum state of one or more quantum objects confined by the photonic-integrated confinement apparatus system. In various embodiments, one or more of the components of the signal management system (active and/or passive components) are formed and/or disposed on the confinement apparatus chip itself, a bridge chip, and/or a cloud chip.

In an example embodiment, the photonic-integrated confinement apparatus system comprises one or more bridge chips 205. Each of the one or more bridge chips may have one or more bridge optical elements disposed and/or formed thereon and/or therein. As used herein, a bridge optical element is an optical element formed and/or disposed on a bridge chip. In various embodiments, a bridge chip is configured to provide manipulation signals and/or other optical signals to one or more optical elements disposed on the confinement apparatus chip. In various embodiments, a bridge chip may span regions that involve varying temperatures and/or pressures (e.g., within a cryogenic and/or vacuum chamber within which the confinement apparatus chip is disposed).

Alternatively, or additionally, in an example embodiment, the photonic-integrated confinement apparatus system comprises one or more delivery chips 215. In various embodiments, a delivery chip is configured to provide manipulation signals and/or other optical signals to one or more optical elements disposed on the confinement apparatus chip, one or more bridge chips, and/or defined positions of the confinement apparatus. For example, in various embodiments, a delivery chip comprises one or more delivery optical elements. As used herein, a delivery optical element is an optical element disposed and/or formed on a delivery chip.

In an example embodiment, a delivery chip may be disposed within the cryogenic and/or vacuum chamber within which the confinement apparatus chip is disposed or external thereto. In various embodiments, delivery chips may be configured in various physical orientations. An example of a delivery chip is a cloud chip. In various embodiments, the photonic-integrated confinement apparatus system comprises one or more cloud chips. Each of the one or more cloud chips may have one or more optical elements disposed and/or formed thereon and/or therein. The confinement apparatus chip may be configured such that when appropriate voltage signals are applied to electrical components (e.g., electrodes) thereof, an electric potential is generated that is configured to confine quantum objects at the defined positions.

In various embodiments, the signal management system comprises active and/or passive optical elements configured for generating, providing, collecting/detecting, and/or controlling parameters of manipulation signals applied to various positions defined by the photonic-integrated confinement apparatus. In various embodiments, the optical elements of the signal management system comprise one or more diffractive optical elements, passive metasurfaces, active metasurfaces, optical modulators, waveguides, amplifiers, on-chip lasers, photodetectors, grating couplers, beam splitters, edge couplers, optical local oscillators, tapers, reference cavities, light absorbing structures, anti-reflection coatings, optical routing elements, resonant structures, and/or the like. In various embodiments, various optical elements of the signal management system have electronic components associated therewith (e.g., the optical elements may be active optical elements with electrically controlled aspects), and other optical elements of the signal management system do not have electronic components associated therewith (e.g., the optical elements may be passive optical elements and/or active elements controlled via a technique other than electric signal-based control). In an example embodiment, a manipulation signal is generated by an on-chip laser and/or the like formed on the confinement apparatus chip, bridge chip, and/or cloud chip.

In various embodiments, a quantum object is a neutral or ionic atom; neutral, ionic, or multipole molecule; quantum particle; quantum dot; and/or other object having quantum states that can be manipulated and/or controlled. The quantum object may be qubit quantum object of a quantum object crystal comprising two or more quantum objects, with, in an example embodiment, the two or more quantum objects of the quantum object crystal comprising, for example, ions of at least two different atomic numbers. In an example embodiment, the photonic-integrated confinement apparatus system is an ion trap (e.g., a surface ion trap, Paul trap, and/or the like) having one or more optical elements integrated therein. For example, the ion trap may be formed, defined, and/or disposed on a confinement apparatus chip. The confinement apparatus chip may be associated with one or more bridge chips and/or one or more cloud chips. The apparatus chip, bridge chip(s), and/or cloud chip(s) may have one or more optical elements formed and/or disposed thereon and/or therein.

Photonic-integrated apparatus systems, including photonic-integrated ion traps are sensitive to film thickness. For instance, within wafer and/or wafer-to-wafer thickness non-uniformity can lead to reduced performance of photonic-integrated ion traps. Fabrication of a multi-layer photonic-integrated ion trap, for example, may comprise several depositions and patterning to define the layers of the ion trap. Each deposition and patterning process may contribute to thickness variability. For example, a deposition typically puts the corresponding film under stress, resulting in film thickness variability. As photonics pass through the ion trap, the accumulated thickness errors (e.g., aggregated thickness errors) from the layers of the ion trap may reduce performance of the ion trap. For example, the optical path that a photonic beam travels, whether in the upward order that is launched out and/or in the downward order launched out of the grating, may be impacted by variability in the thickness of the layers of the multi-layered ion trap. The accumulated thickness errors can cause reflections to destructively interfere with the output beam. Likewise, the beam may be outputted at a different location from the target as a result of the thickness errors.

Various embodiments provide technical solutions to these technical problems and other technical problems associated with integrated photonics. In various embodiments, one or more trimming operations is applied to layer(s) of a confinement apparatus to correct thickness errors based on the thickness map(s) of the layer(s). In various embodiments, a pattern recognition thickness metrology technique is leveraged to generate the thickness map for one or more layers (e.g., waveguide core layer, top cladding layer above the waveguide core layer, bottom cladding layer below the waveguide core layer, metal layer trimming, and/or the like). In various embodiments, a material agnostic trimming operation, for example, thickness trimming is applied to the one or more layers during fabrication of the confinement apparatus to trim the one or more layers such that desired target thickness and/or thickness uniformity is achieved. In various embodiments, a layer is trimmed using the thickness trimming to achieve desired thickness uniformity.

By using thickness trimming, which enables achievement of desired target thickness and thickness uniformity, and may be material agnostic (e.g., material independent), various embodiments, of the present disclosure provide absolute thickness control and allow die-to-die and/or zone-zone consistency for design validation and ion trap yield.

### Example Quantum Computing System Comprising an Atomic Object Confinement Apparatus Quantum Computer System

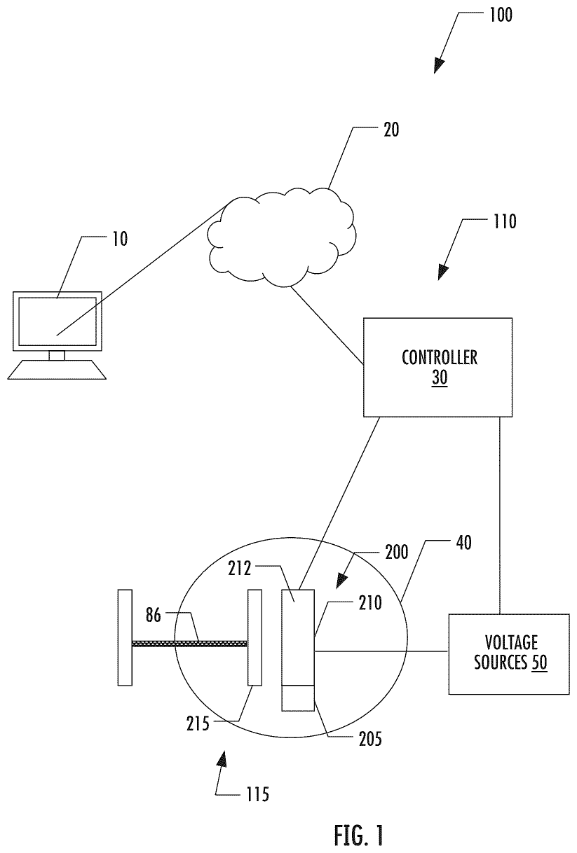

FIG. 1 provides a schematic diagram of an example quantum computing system 100 comprising a photonic-integrated confinement apparatus system 200, in accordance with an example embodiment. In various embodiments, the photonic-integrated confinement apparatus system 200 comprises a confinement apparatus chip 210. In various embodiments, the electrical elements that define and/or form the confinement apparatus (e.g., photonic-integrated confinement apparatus) 212 are formed and/or disposed on the confinement apparatus chip 210. In various embodiments, the photonic-integrated confinement apparatus system 200 may also comprise one or more bridge chips 205, one or more cloud chips, and/or the like. Each of the one or more bridge chips may have one or more optical elements disposed and/or formed thereon and/or therein. Each of the one or more cloud chips may have one or more optical elements disposed and/or formed thereon and/or therein.

In various embodiments, the quantum computing system 100 comprises a signal management system. In various embodiments the signal management system comprises one or more optical elements formed and/or disposed on and/or in the confinement apparatus chip 210, bridge chip(s), and/or delivery chip(s). In various embodiments, the signal management system further comprises optical elements formed and/or disposed on and/or in one or more external chips 260 that are external to the cryogenic and/or vacuum chamber 40. For example, the one or more optical elements formed and/or disposed on and/or in the one or more external chips may be coupled to respective optical elements formed and/or disposed on and/or in the confinement apparatus chip 210, bridge chip(s), and/or delivery chip(s) via optical fibers 86 and/or free space optics.

In various embodiments, the quantum computing system 100 comprises a computing entity 10 and a quantum computer 110. In various embodiments, the quantum computer 110 comprises a controller 30 and a quantum processor 115. In various embodiments, the quantum processor 115 comprises a cryogenic and/or vacuum chamber 40 enclosing a photonic-integrated confinement apparatus system 200 (e.g., an ion trap), one or more external chips comprising components of the signal management system, and/or one or more voltage sources configured to provide voltage signals to the electrical components of the photonic-integrated confinement apparatus system 200.

In various embodiments, the cryogenic and/or vacuum chamber 40 is a temperature and/or pressure-controlled chamber. For example, the quantum computing system 100 may comprise vacuum and/or temperature control components that are operatively coupled to the cryogenic and/or vacuum chamber 40.

In various embodiments, the quantum computer 110 comprises one or more voltage sources 50. For example, the voltage sources 50 may comprise a plurality of voltage drivers and/or voltage sources and/or at least one RF driver and/or voltage source. The voltage sources 50 may be electrically coupled to the corresponding electrode elements (e.g., electrodes) of the confinement apparatus, in an example embodiment. For example, the electric and/or electromagnetic field formed at least in part by applying the voltage signals generated by the voltage source 50 to the electrical elements of the confinement apparatus cause and/or form the confinement region(s) of the confinement apparatus.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms and/or circuits, and/or the like into a computing language, executable instructions, command sets, and/or the like that the controller 30 can understand and/or implement.

In various embodiments, the controller 30 is configured to control and/or in electrical communication with the voltage sources 50, cryogenic system and/or vacuum system controlling the temperature and/or pressure within the cryogenic and/or vacuum chamber 40, manipulation sources, and/or other systems controlling various environmental conditions (e.g., temperature, pressure, and/or the like) within the cryogenic and/or vacuum chamber 40 and/or configured to manipulate and/or cause a controlled evolution of quantum states of one or more quantum objects within the confinement apparatus. In various embodiments, the quantum objects confined within the confinement apparatus are used as qubits of the quantum processor 115 and/or quantum computer 110.

In various embodiments, the photonic-integrated confinement apparatus system 200 is a confinement apparatus configured to confine one or more atomic objects therein and the manipulation sources are configured to provide manipulation signals to one or more portions of the photonic-integrated confinement apparatus system 200 via optical paths (e.g., photon beam paths). In various embodiments, the atomic objects confined or trapped within the confinement apparatus are ions, atoms, and/or the like. For example, in an example embodiment, an atomic object may comprise ytterbium ion or other ions. In an example embodiment, an atomic object comprises a qubit ion and a corresponding cooling ion.

In various embodiments, the manipulation signals may be used to initialize one or more atomic objects into a qubit space, perform cooling operations, perform measurement operations, provide one or more gate signals, and/or the like. For example, a photonic beam may be provided to a target, for example, a qubit of a quantum computer. For example, the target may be trapped in an ion trap (e.g., of a ion quantum computer) and the photonic beam may be used to ionize an atom being loaded into the ion trap, initialize an ion within the ion trap into a known quantum state, perform a quantum logic gate on an ion, perform cooling of an ion within the ion trap, re-pump an ion within the ion trap, and/or the like.

In an example embodiment, the manipulation sources comprise one or more laser systems (e.g., UV lasers, visible lasers, microwave lasers, and/or the like) configured to provide one or more manipulation signals configured to manipulate and/or cause a controlled quantum state evolution of one or more ions within the confinement apparatus. For example, in an example embodiment, where the one or more manipulation sources comprise one or more lasers, the lasers may provide one or more laser beams to the confinement apparatus within the cryogenic and/or vacuum chamber 40. For example, a manipulation source may provide a laser beam and/or the like to the photonic-integrated confinement apparatus system 200 via a beam path. For example, in an example embodiment, the manipulation signals may be provided to the one or more portions of the confinement apparatus via beam paths. In an example embodiment, the paths may include or otherwise is associate with a beam delivery photonic-integrated circuit.

### Example Photonic-Integrated Confinement Apparatus

In various embodiments, the photonic-integrated confinement apparatus system 200 comprises a confinement apparatus 212 (e.g., photonic-integrated confinement apparatus 212). The confinement apparatus 212 comprises a plurality of electrical elements such as electrodes, in an example embodiment, that are configured to generate a confining potential. In various embodiments, the plurality of electrodes of the confinement apparatus 212 are formed and/or disposed on a confinement apparatus chip 210. For example, the controller 30 may control the voltage sources 50 to provide electrical signals to the electrodes of the confinement apparatus 212 such that the electrodes generate a confining potential. The confining potential is configured to confine a plurality of quantum objects within a confinement volume defined by the confinement apparatus 212. For example, in an example embodiment, the confinement apparatus 212 is a surface ion trap and the confinement volume is a volume located proximate the surface of the surface ion trap. For example, the confinement apparatus 212 is a multi-layered ion trap and the confinement volume is a volume located proximate the uppermost layer of the multi-layered ion trap. In various embodiments, the electrodes and/or confining potential are configured to define a plurality of defined positions within the confinement volume.

In various embodiments, the voltage sources 50 provide respective electrical signals to the respective electrical elements of the confinement apparatus 212, such that a confining potential is formed. Based on the contours and time evolution of the confining potential (controlled by the controller 30 via controlling the operation of the voltage sources 50) one or more quantum objects are confined at respective defined positions moved between defined positions and/or the like. When a quantum object is located at a defined position, one or more functions (e.g., quantum computing functions) may be performed on the quantum object.

An example function that may be performed on quantum object is photoionization of the quantum object. For example, a manipulation signal may be applied to the quantum object (e.g., an atom or molecule) to photo ionize the quantum object.

Another example function that may be performed on a quantum object is state preparation of the quantum object. For example, one or more manipulation signals may be applied to the quantum object to prepare the quantum object in a particular quantum state. For example, the particular quantum state may be a state within a defined qubit space used by the quantum computer such that the quantum object may be used as a qubit of the quantum computer.

Another example function that may be performed on a quantum object is reading a quantum state of the quantum object. For example, a manipulation signal (e.g., a reading signal) may be applied to the quantum object. When the quantum object's wave function collapses into a first state of the qubit space, the quantum object will fluoresce in response to the reading signal being applied thereto. When the quantum object's wave function collapses into a second state of the qubit space, the quantum object will not fluoresce in response to the reading signal being applied thereto. A photodetector configured to receive signals emitted by a quantum object disposed at a respective defined position 225 may then detect whether or not the quantum object fluoresced such that the quantum state of the quantum object is determined.

Another example function that may be performed on a quantum object is cooling the quantum object or a quantum object crystal comprising the quantum object. A quantum object crystal is a pair or set of quantum objects where at least one of the quantum objects of the quantum object crystal is qubit quantum object used as a qubit of the quantum computer and at least one quantum objects of the quantum object crystal is used to perform sympathetic cooling of the qubit quantum object. For example, a manipulation signal (e.g., a cooling signal or a sympathetic cooling signal) may be applied to the quantum object or quantum object crystal to cause the (qubit) quantum object to be cooled (e.g., reduce the vibrational and/or other kinetic energy of the (qubit) quantum object).

Another example function that may be performed on a quantum object is shelving the quantum object. In various embodiments, quantum objects in the second state of the qubit space may be shelved during the performance of a reading function. For example, a shelving operation may comprise causing the quantum state of a quantum object in the second state of the qubit space to evolve to an at least meta-stable state outside of the qubit space while a reading operation is performed. In various embodiments, the shelving of a quantum object is performed by applying one or more manipulation signals to the quantum object to cause the quantum object's quantum state to evolve to an at least meta-stable state outside of the qubit space when the quantum object is in the second state of the qubit space.

Another example function that may be performed on a quantum object is (optical) repumping of the quantum object. In various embodiments, repumping of the quantum object comprises applying one or more manipulation signals to the quantum object to cause the quantum state of the quantum object to evolve to an excited state.

Another example function that may be performed on a quantum object is performing a single qubit gate on the quantum object. For example, one or more manipulation signals may be applied to the quantum object to perform a single qubit quantum gate (e.g., a single qubit logical function) on the quantum object.

Another example function that may be performed on a quantum object is performing a two qubit gate on the quantum object. For example, one or more manipulation signals may be applied to a pair or set of quantum objects that includes the quantum object to perform a two qubit (or three, four, or more) quantum gate (e.g., a multiple qubit logical function) on the quantum object and the at least one other quantum object.

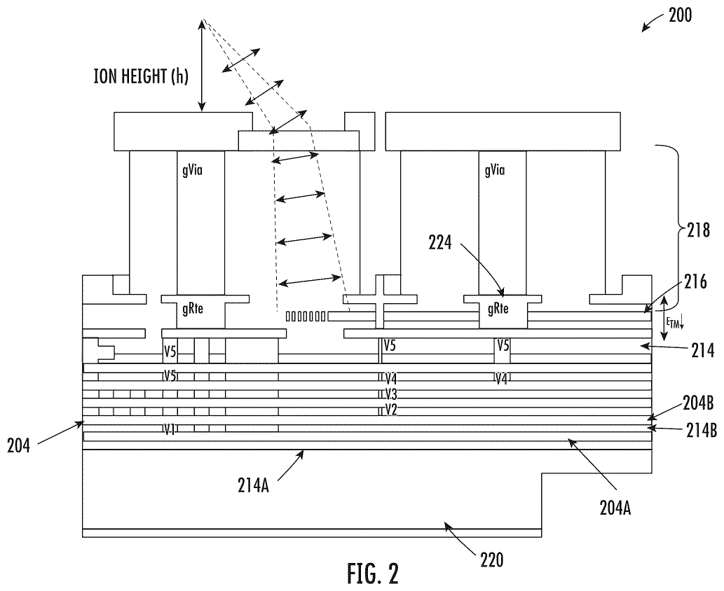

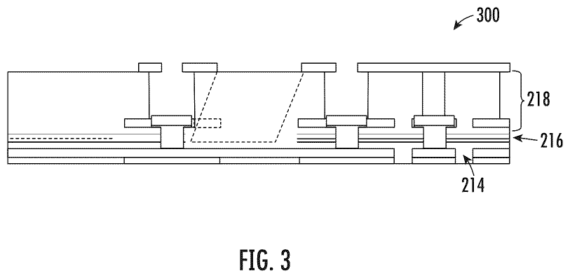

FIG. 2 provides a cross section of at least a portion of an example photonic-integrated confinement apparatus system 200. Specifically FIG. 2 depicts a cross section of at least a portion of an example photonic integrated confinement apparatus system 200 having multi-layered bottom cladding layer. FIG. 3 provides a cross section of at least a portion of an example photonic-integrated confinement apparatus system 300 having single layer bottom cladding layer. In an example embodiment the confinement apparatus 212 is multi-layered ion trap. The photonic-integrated confinement apparatus system 200 comprises a confinement apparatus chip 210. In various embodiments, the confinement apparatus chip 210 is a substrate 220 comprising electrical elements, such as sequences of electrodes that are configured to generate the confining potential of the photonic-integrated confinement apparatus system 200. For example, the substrate 220 may comprise a silicon wafer. It would be appreciated that the substrate 220 may be made of one or more of a variety of materials.

In various embodiments, one or more features, for example, metals, are embedded within a bottom cladding layer 214. In an example embodiment, one or more metal layers 204 is formed and/or disposed on the substrate 220. For example, a plurality of segmented metal layers may be formed and/or disposed on the substrate 220. For example, a metal layer 204 may comprise a plurality of metals that are spaced apart (e.g., horizontally spaced apart). In various embodiments, the one or more metals layers 204 is embedded within a bottom cladding layer 214. For example, the bottom cladding layer 214 may enclose the one or more metals layers 204. For example, the bottom cladding layer 214 may be multi-layered (e.g., comprise or otherwise define a plurality of layers). Each metal layer 204 may be separated by a layer of the plurality of layers of the bottom cladding layer 214. The bottom cladding layer 214 may comprise one or more layers, where at least a portion of the one or more layers are formed from cladding material. Non-limiting examples of the cladding material comprise oxide and/or dielectric material such as, for example, SiO2. For example, in an example embodiment, the bottom cladding layer 214 may comprise one or more oxide and/or dielectric layers. For example, in an example embodiment, the bottom cladding layer 214 comprise one or more layers made of SiO₂. (e.g., the bottom cladding layer 214 may comprise one or more SiO2 films in some embodiments). A metal layer such as metal layers 204 formed and/or disposed within the bottom cladding layer 214 may be referred to as bottom cladding metal layer.

In various embodiments, thickness trimming is previously applied to the bottom cladding layer 214 to correct thickness uniformity errors that, for example, can result in optical loss, reduce yield, and/or the like. For example, thickness trimming is previously applied to the bottom cladding layer 214 to etch the bottom cladding layer 214 so that desired target thickness and/or thickness uniformity is achieved, to minimize optical loss and improve yield. For example, thickness trimming may be configured to trim a wafer within, for example, 100 nm or less, 50 nm or less, 10 nm or less, and/or the like, whereby the wafer has uniform thickness that satisfies desired target thickness and/or thickness uniformity specification, and such that optical loss and yield impact due to thickness variability are minimized. In some embodiments, the thickness trimming technique comprises ion beam trimming, fluid jet polishing, magnetorheological finishing, and/or other thickness trimming techniques. In some embodiments, ion beam trimming comprises feeding an ion beam trimming system with a wafer thickness map and removing material across the wafer using a focused ion beam and based on the wafer thickness map. For example, a focused ion beam (e.g., comprising argon, and/or the like) may be rastered across the wafer while determining the dwelling time at a particular location for removing (e.g., milling away) material based on the wafer thickness at that particular location as indicated in the wafer thickness map. In this regard, the amount of material removed (e.g., milled away) from a particular location on the wafer is based on the thickness at the particular location as indicated in the corresponding wafer thickness map. For example, the ion trimming system can estimate how long to dwell the ion beam (e.g., argon beam, and/or the like) at each pixel based on the thickness map to create a uniform layer.

In an example embodiment, applying thickness trimming to the bottom cladding layer 214 comprises applying thickness trimming to each layer of the multi-layered bottom cladding. For example, thickness trimming, as described above, may be applied to each layer of the bottom cladding layer 214 from the first cladding layer of the bottom cladding layer 214 to the upper most cladding layer of the bottom cladding layer 214 after a respective layer is formed and/or disposed on the substrate 220 before the next layer is formed and/or disposed on the substrate 220. In an example embodiment, applying thickness trimming to the bottom cladding layer 214 comprises applying thickness trimming to the multi-layered bottom cladding as a whole (e.g., as one unit). For example, thickness trimming may be applied to the bottom cladding layer 214 after all layers of the bottom cladding layer 214 have been formed and/or disposed on the substrate 220. In an example embodiment, applying thickness trimming to the bottom cladding layer 214 comprises applying thickness trimming to a portion of the layers of the multi-layered bottom cladding.

In an example embodiment, chemical mechanical polishing (CMP) and/or other polishing operations is previously applied to the bottom cladding layer 214 prior to thickness trimming of the bottom cladding layer. For example, the bottom cladding layer 214 may be planarized using CMP and/or other polishing techniques before etching the bottom cladding layer using thickness trimming. For example, CMP may be applied to the bottom cladding layer before thickness trimming is applied, in an example embodiment. For example, CMP may not be applied to the bottom cladding layer 214, in an example embodiment. Alternatively or additionally, in some embodiments, the bottom cladding layer 214 may be planarized using CMP and/or other polishing techniques after thickness trimming.

It would be appreciated that in some embodiments, other trimming and/or polishing techniques and/or combination of trimming and/or polishing techniques may be leveraged to correct thickness errors in the bottom cladding layer 214.

In various embodiments, thickness trimming is previously applied to one or more of the metal layers to correct thickness errors. For example, thickness trimming may be previously applied to the metal layer(s) to etch a respective metal layer to a desired target thickness and/or thickness uniformity. In an example embodiment, CMP is previously applied to the metal layer(s) prior to thickness trimming of the metal layer(s). For example, a respective metal layer may be planarized using CMP and/or other polishing techniques before etching the respective metal layer using thickness trimming. For example, CMP may be applied to a respective metal layer before thickness trimming is applied, in an example embodiment. For example, CMP may not be applied to a respective metal layer, in an example embodiment. Alternatively or additionally, in some embodiments, metal layers may be planarized using CMP and/or other polishing techniques after thickness trimming.

In various embodiments, the confinement apparatus chip 210 further comprises at least one optical element disposed and/or formed on and/or in the confinement apparatus chip 210. The confinement apparatus chip 210, for example, may comprise one or more manipulation sources, amplifiers, beam splitters, optical modulators, signal manipulation elements, photodetectors, waveguides, grating couplers, edge couplers, tapers, reference cavities, light absorbing structures, anti-reflective coatings, routing elements, resonant structures, and/or other optical elements. In various embodiments and as illustrated in FIG. 2, the confinement apparatus chip 210 comprises at least one waveguide core layer 216 (e.g., photonic layer) disposed and/or formed on the bottom cladding layer 214. For example, the bottom cladding layer 214 may be sandwiched between the waveguide core layer 216 and the confinement apparatus chip 210. The waveguide core layer 216, for example, may comprise a waveguide. In an example embodiment, the waveguide core layer 216 may comprise intermediate layer(s) that enclose the waveguide core. For example, a first intermediate layer may be sandwiched between the waveguide core and the surface of the bottom cladding layer 214 (e.g., surface of the uppermost layer of the bottom cladding layer 214). For example, a second intermediate layer may be sandwiched between the waveguide core and a top cladding 218. In various embodiments, the waveguide core may have a refractive index that is higher than the refractive index of the bottom and top cladding layers 214, 218.

The waveguide core layer 216 (e.g., waveguide core thereof) may be configured to propagate photonic beams through the waveguide. For example, the waveguide core layer 216 may define a photonic beam path, such that photonic beam(s) travel through the confinement apparatus 212 (e.g., via the waveguide) from an input side of the waveguide to an output side of the waveguide. In various embodiments, the waveguide core comprises a grating (e.g., waveguide grating). For example, a portion of the waveguide core comprises or otherwise defines a waveguide grating, for example, at the output side of the waveguide. For example, the waveguide grating may be configured to direct photonic beam traveling through the confinement apparatus 212 (e.g., via the waveguide) to a target and/or target region.

In an example embodiment, the waveguide core layer 216 may form a portion of and/or may be connected to a beam delivery photonic-integrated circuit. The beam delivery photonic-integrated circuit for example may form a portion of and/or embodied by the signal management system. The beam delivery photonic-integrated circuit may be located external to the vacuum chamber or, alternatively, a beam delivery photonic-integrated circuit may be located inside the vacuum chamber 40.

In an example embodiment, the waveguide may comprise a passive wave guide and/or an active wave guide. In various embodiments, the passive waveguide is made of a material having a refractive index that allows for propagation of a photonic beam through the waveguide with only a small amount of loss (e.g., via dissipation and/or leakage). The passive waveguide, for example, may be made of Al₂O₃, Si₃N₄, HfO₂, AlN, and/or Ta₂O₅. The active waveguide, for example, may be made of LiNbO₃, LiTaO₃, or BaTiO₃.

In various embodiments, thickness trimming is previously applied to the waveguide core layer 216 to correct thickness errors. For example, thickness trimming is previously applied to the waveguide core to etch the waveguide core to a desired target thickness and/or thickness uniformity. In an example embodiment, CMP is previously applied to the waveguide core prior to thickness trimming of the waveguide core. For example, a waveguide core may be planarized using CMP and/or other polishing techniques before etching the waveguide core using thickness trimming. For example, CMP may be applied to the waveguide core before thickness trimming is applied, in an example embodiment. For example, CMP may not be applied to the waveguide core, in an example embodiment. Alternatively or additionally, in some embodiments, the waveguide core may be planarized using CMP and/or other polishing techniques after thickness trimming.

In various embodiments, a top cladding layer 218 is disposed on the waveguide core layer 216. In some embodiments, disposing the top cladding layer 218 on the waveguide core layer 216 comprises disposing cladding material on the waveguide core layer 216 such that the waveguide core layer 216 is embedded between the top cladding layer 218 and the bottom cladding layer 214. In some embodiments, the top cladding layer is disposed and/or formed partially on the waveguide core layer 216 and partially on the bottom cladding layer 214. For example, the bottom cladding layer 214 and the top cladding layer 218 may enclose the waveguide core layer 216. For example, the bottom and top cladding layers 214, 218 may have a width in a direction substantially parallel to the surface of the confinement apparatus chip 210 that is greater than the width of the waveguide core layer 216 such that the waveguide core layer 216 is enclosed by the bottom and top cladding layers 214, 218. In various embodiments, the top cladding layer 218 is an oxide and/or dielectric layer. For example, the top cladding layer 218 may be made of SiO₂, material, in an example embodiment. For example, the top cladding layer 218 may comprise SiO2 film. It should be understood that in some embodiments, the top cladding layer 218 and/or the bottom cladding layer 214 may be made from other materials.

In some embodiments, one or more features are embedded within the top cladding layer 218, where the one or more features comprise metal(s). The metal(s) embedded within the top cladding layer 218 may define one or more layers (e.g., metal layers) of the top cladding layer 218. For example, in some embodiments, one or more metal layers are formed and/or disposed within the top cladding layer 218, where each metal layer comprises one or more metals. For example, in some embodiments, the top cladding layer 218 may be multi-layered (e.g., comprise or otherwise define a plurality of layers). In such embodiments, each metal layer may be separated by a layer of the plurality of layers of the top cladding layer 218. Non-limiting examples of such metals include copper (Cu) and Aluminum (Al). A metal layer disposed and/or formed within the top cladding layer 218 may be referred to as a top cladding metal layer.

In some embodiments, at least one metal layer of the one or more metal layers formed and/or disposed within the top cladding layer 218 is a segmented metal layer. For example, the at least one metal layer may comprise a plurality of metals that are spaced apart (e.g., horizontally spaced apart). In this regard, the at least one metal layer may comprise a sequence of metals (e.g., Cu, Al, and/or the like) with a gap between adjacent (e.g., horizontally adjacent) metals.

In various embodiments, the at least one metal layer may be formed by depositing a metal on the uppermost layer formed/disposed on the substrate 220 (e.g., waveguide core layer 216 in various embodiments) and etching one or more locations on the deposited metal to segment the metal into a plurality of individual metals. In a particular embodiment, the top cladding layer 218 comprises a plurality of metal layers where each of one or more of the plurality of metal layers is formed by depositing a metal on the uppermost layer formed/disposed on the substrate 220 and etching one or more locations on the deposited metal to segment the metal into a plurality of individual metals. In an example embodiment comprising a plurality of metal layers, at least some of the metal layers may be vertically separated from each other. In various embodiments, thickness trimming is previously applied to the top cladding layer 218 to correct thickness errors associated with the top cladding layer 218. For example, thickness trimming is previously applied to the top cladding layer 218 to etch the top cladding layer 218 to a desired target thickness and/or thickness uniformity.

In some embodiments, the thickness trimming technique comprises ion beam trimming, fluid jet polishing, magnetorheological finishing, and/or other thickness trimming techniques. In some embodiments where the thickness trimming applied to the top cladding layer 218 is ion beam trimming, such ion beam trimming may be performed as described above with respect to the bottom cladding layer 214.

In an example embodiment, applying thickness trimming to the top cladding layer 218 comprises applying thickness trimming to each layer of a multi-layered top cladding 218 or at least a portion of the layers of the multi-layered top cladding 218. For example, thickness trimming, as described above, may be applied to each layer or some layers of the top cladding layer 218 from the first cladding layer of the top cladding layer 218 to the upper most cladding layer of the top cladding layer 218 after a respective layer is formed and/or disposed before the next layer is formed and/or disposed. In an example embodiment, applying thickness trimming to the top cladding layer 218 comprises applying thickness trimming to a multi-layered top cladding as a whole (e.g., as one unit). For example, thickness trimming may be applied to the top cladding layer 218 after all layers of the top cladding layer 218 have been formed and/or disposed. It would be appreciated that in some embodiments, other trimming and/or polishing techniques and/or combination of trimming and/or polishing techniques may be leveraged to correct thickness errors in the top cladding layer 218.

In various embodiments, thickness trimming is previously applied to one or more of the metal layer(s) formed and/or disposed within the top cladding layer 218 to correct thickness errors. For example, thickness trimming may be previously applied to the metal layer(s) to etch a respective metal layer to a desired target thickness and/or thickness uniformity. In an example embodiment, CMP may be previously applied to the metal layer(s) prior to thickness trimming of the metal layer(s). For example, a respective metal layer may be planarized using CMP and/or other polishing techniques before etching the respective metal layer using thickness trimming. For example, in some embodiments CMP may be applied to a respective metal layer before thickness trimming is applied. It would be appreciated that in some embodiments, CMP may not be applied to the metal layer(s).

In an example embodiment, CMP is previously applied to the top cladding layer 218 prior to thickness trimming of the top cladding layer 218. For example, the top cladding layer 218 may be planarized using CMP and/or other polishing techniques before etching the top cladding layer 218 using thickness trimming. For example, CMP may be applied to the top cladding layer 218 before thickness trimming is applied, in an example embodiment. For example, CMP may not be applied to the top cladding layer 218, in an example embodiment. Alternatively or additionally, in some embodiments, the top cladding layer 218 may be planarized using CMP and/or other polishing techniques after thickness trimming.

In various embodiments, the confinement apparatus chip 210 further comprises electrical contacts 224. For example, via openings may be etched into the bottom cladding layer 214 and/or top cladding layer 218, and electrical contacts 224 may be deposited into the via openings. For example, one or more electrical contacts 224 may be in electrical communication with the waveguide layer.

In various embodiments, thickness trimming, as described herein is performed on the bridge chip, delivery chip, and/or the external chip. For example, thickness trimming may be performed on one or more layers of the bridge chip, delivery chip, and/or the external chip based on the corresponding thickness map.

### Example Method of Fabricating a Photonic-Integrated Confinement Apparatus

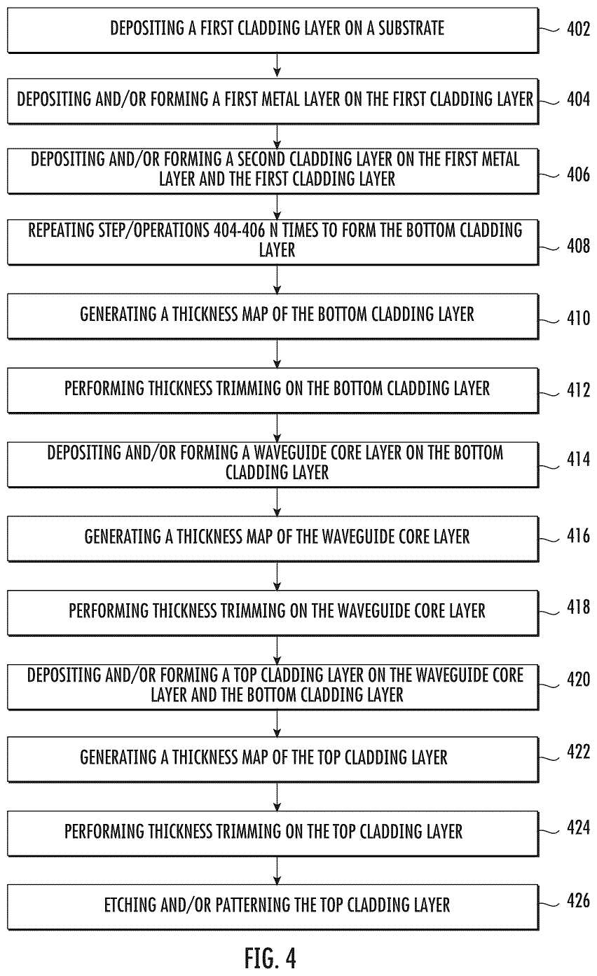

FIG. 4 provides a flowchart illustrating processes, procedures, operation, and/or the like performed to fabricate a photonic-integrated confinement apparatus 212.

Starting at step/operation 402 of FIG. 4, a first cladding layer 214A is deposited on a substrate 220. For example, an oxide and/or dielectric film, for example, SiO2 film may be deposited on the substrate 220. For example, the substrate 220 may comprise a silicon wafer. As another example, the substrate 220 may comprise a wafer with one or more layers (e.g., sub-layer(s)) below the wafer.

At step/operation 404, a first metal layer 204A is deposited and/or formed on the first cladding layer 214A. The first metal layer 204A may comprise a plurality of metals that are spaced apart (e.g., horizontally spaced apart). For example, the first metal layer 204A may comprise a sequence of metals (e.g., Cu, Al, and/or the like) with a gap between adjacent metals. In an example embodiment, a portion of the first metal layer 204A may be formed by depositing a metal on the first cladding layer 214A and etching one or more locations on the metal to segment the metal into two or more metals.

At step/operation 406, a second cladding layer 214B is deposited and/or formed on the first metal layer 204A. In some embodiments, depositing and/or forming the second cladding layer 214B on the second cladding layer 214B comprises depositing cladding material on the surface of the first metal layer 204A. The cladding material, for example, may comprise oxide and/or dielectric film such as, for example, SiO2 film or any other suitable cladding material. In some embodiments where the first metal layer 204A comprises a plurality of metals that are spaced apart, depositing and/or forming the second cladding layer 214B may comprise depositing cladding material on the metal(s) in the first metal layer 204A and exposed surface of the first cladding layer 214A. For example, an oxide and/or dielectric, for example, SiO2 film may be deposited and/or formed on the first metal layer 204A and the first cladding layer 214A. For example, a second cladding layer 214B is deposited and/or formed on each metal of the plurality of metals of the first metal layer 204A, as well as the gap(s) between adjacent metals. The second cladding layer 214B may represent or otherwise correspond to the third layer of the bottom cladding layer 214. In some embodiments, the first layer of a multi-tiered bottom cladding layer 214 may be a metal layer. For example, a first metal layer 204A may be deposited on a substrate 220 and other layers of the multi-tiered bottom cladding layer 214 disposed above first metal layer 204A.

At step/operation 408, steps/operations 404-406 may be repeated N (e.g., N=0, 1, 2, 3, and/or the like) times, such that a plurality of alternating metal layers and cladding layers are formed on the substrate 220. The plurality of cladding layers may collectively define a bottom cladding layer 214. For example, in an example embodiment, one or more features are patterned within the bottom cladding layer, where the one or more features may comprise one or more metal layers. In an example embodiment, a plurality of features comprising a plurality of metal layers are patterned within the bottom cladding layer.

At step/operation 410, a thickness map (e.g., wafer thickness map) of the bottom cladding layer 214 is generated. In an example embodiment, the thickness map is generated using a pattern recognition thickness metrology technique configured to measure film thickness at various locations of a film. For example, the thickness map generated for the bottom cladding layer 214 may comprise thickness values across the bottom cladding layer 214. The pattern recognition metrology may be configured to navigate around the metal layers (e.g., first metal layer 204A, second metal layer 204B, and/or the like) embedded in the bottom cladding layer 214 to measure the thicknesses across the bottom cladding layer 214.

At step/operation 412, the bottom cladding layer 214 is trimmed to correct thickness errors in the bottom cladding layer using one or more polishing techniques and based on the thickness map for the bottom cladding layer 214. For example, thickness trimming may be performed on the bottom cladding layer to reduce thickness variation in the bottom cladding layer 214. In various embodiments, the thickness trimming is performed on the bottom cladding layer 214 based on the thickness map for the bottom cladding layer 214 For example, ion beam trimming may be performed, where focused ion beam is rastered across the bottom cladding layer 214 and an amount of material is removed from one or more locations on the bottom cladding layer 214 based on the thickness at the respective locations. For example, in various embodiments, a focused ion beam is rastered across the bottom cladding layer 214, and the dwelling time for removing (e.g., milling away) material at a particular location is determined based on the thickness at that particular location as indicated in the thickness map for the bottom cladding layer 214. The amount of material removed from a particular location may depend on the dwelling time at the particular location.

In an example embodiment, the uppermost layer of the bottom cladding layer 214 is polished to, for example, planarize the bottom cladding layer 214. For example, CMP and/or other polishing techniques may be applied to the uppermost layer of the bottom cladding layer 214. For example, CMP and/or other polishing techniques may be applied to the bottom cladding layer 214 prior to applying thickness trimming to the bottom cladding layer 214. Alternatively or additionally, in some embodiments, CMP and/or other polishing techniques may be applied to the bottom cladding layer 214 after applying thickness trimming to the bottom cladding layer 214.

In an example embodiment, each cladding layer of the bottom cladding layer 214 is trimmed based on a thickness map for the respective cladding layer and using thickness trimming, as described herein. Alternatively, or additionally, CMP and/or other polishing techniques may be applied to a respective cladding layer prior to applying thickness trimming.

In an example embodiment, the metal layers embedded in the bottom cladding layer 214 are trimmed to correct thickness in the metal layers using one or more polishing techniques and based on the thickness map of the metal layer. For example, thickness trimming may be performed on the metal layers to reduce thickness variation in the metal layers. The metal layers, for example, may comprise features within the bottom cladding layer 214. In an example embodiment, each metal layer is trimmed using thickness trimming and based on the thickness map for the respective metal layer prior to depositing a cladding layer on the respective metal layer. In an example embodiment, the bottom cladding layer 214 comprises a single cladding layer, such that trimming of metals may not be necessary. For example, the photonic-integrated confinement apparatus 212 may not include metal layers below the waveguide core layer.

At step/operation 414, a waveguide core layer 216 is deposited on the bottom cladding layer 214. The bottom cladding layer 214 (which may be embedding with metal(s) in some embodiments), for example, may electrically and/or thermally isolate the waveguide core layer 216 from the substrate 220. For example, a waveguide core layer comprising Al2O3, Si3N4, HfO2, AlN, Ta2O5, and/or the like may be deposited on the uppermost layer of the bottom cladding layer 214. In an example embodiment the waveguide core layer 216 is etched and/or patterned. For example, the waveguide core layer 216 may be etched and/or patterned to form the waveguide core into a desired waveguide geometry. In various embodiments, a photolithography and/or mask etching process may be used to etch the waveguide core layer. For example, in an example embodiment, the waveguide core layer 216 is etched such that width of the waveguide core layer 216 is less than the width of the bottom cladding layer 214. In various embodiments, the waveguide core layer 216 is made of a material having a refractive index that allows for propagation of a photonic beam through the waveguide core layer 216 with only a small amount of loss (e.g., via dissipation and/or leakage), for example, silicon nitride material, aluminum material, and/or the like. In an example embodiment, the waveguide core layer 216 may comprise a passive waveguide and/or an active waveguide. The passive waveguide, for example, may be made of Al₂O₃, Si₃N₄, HfO₂, AlN, and/or Ta₂O₅. The active waveguide, for example, may be made of LiNbO₃, LiTaO₃, or BaTiO₃.

At step/operation 416, a thickness map of the waveguide core layer 216 is generated. In an example embodiment, the thickness map is generated using a pattern recognition thickness metrology technique configured to measure thickness at various locations. For example, the thickness map generated for the waveguide core layer 216 may comprise thickness values across the waveguide core layer 216, for example, at various locations on the waveguide core layer 216.

At step/operation 418, the waveguide core layer 216 is trimmed to correct thickness errors in the waveguide core layer 216 using one or more polishing techniques and based on the thickness map for the waveguide core layer 216. For example, thickness trimming may be performed on the waveguide core layer to reduce thickness variation in the waveguide core layer 216. In various embodiments, the thickness trimming is performed on the waveguide core layer 216 based on the thickness map for the waveguide core layer 216. For example, ion beam trimming may be performed where focused ion beam is rastered across the waveguide core layer 216 and an amount of material is removed from one or more locations on the waveguide core layer 216 based on the thickness at the respective locations. For example, in various embodiments, a focused ion beam is rastered across the waveguide core layer 216, and the dwelling time for removing (e.g., milling away) material at a particular location is determined based on the thickness at that particular location as indicated in the thickness map for the waveguide core layer 216. In various applications, including quantum computing application, grating performance may be affected by thickness variability on the waveguide core layer. Thus, the need to maintain thickness uniformity with respect to the waveguide core layer 216.

In an example embodiment, the waveguide core layer 216 is polished to, for example, to polish out surface roughness. For example, CMP and/or other polishing techniques may be applied to the waveguide core layer 216. For example, CMP and/or other polishing techniques may be applied to the waveguide core layer 216 prior to applying thickness trimming to the waveguide core layer 216.

At step/operation 420, a top cladding layer 218 is deposited and/or formed. For example, the top cladding layer 218 is deposited and/or formed on the waveguide core layer 216 and the bottom cladding layer 214. For example, oxide and/or dielectric film, for example, SiO2 may be deposited and/or formed on the waveguide core layer 216 and the bottom cladding layer 214 (e.g., portion of uppermost layer of the bottom cladding layer 214 that does not have a portion of the waveguide core layer 216 formed and/or disposed thereon). As described above, in an example embodiment, the waveguide core layer 216 may have a width that is less than the width of the bottom cladding layer 214. In an example, embodiment, the width of the waveguide core layer 216 is less than the width of the top cladding layer 218.

In some embodiments, one or more features are patterned within the top cladding layer 218. In some embodiments, the one or more features may comprise one or more metals that define one or more metal layers formed and/or disposed within the top cladding layer 218. In such embodiments, step/operation 420 may comprise depositing cladding material on the upper most layer on the substrate 220 after completion of step/operation 418 (e.g., waveguide core layer 216 in some embodiments) to form a first a first layer of the multi-tiered top cladding layer 218 and depositing one or more metals on the first layer of the multi-tiered top cladding layer 218 to form a first metal layer (that represents a second layer of the multi-tiered top cladding layer 218).

In some embodiments, the first metal layer comprises a plurality of metals that are spaced apart (e.g., horizontally spaced apart). In such embodiments, the first metal layer may be formed by depositing a metal on the first layer of the multi-tiered top cladding layer 218 and etching one or more locations on the deposited metal to segment the metal into a plurality of individual metals that are spaced apart. In some embodiments, cladding material may be deposited on the second layer (e.g., first metal layer) of the multi-tiered top cladding layer 218 to form a third layer of the multi-tiered top cladding layer 218.

In some embodiments, one or more metals and cladding material may be further deposited as described above to form additional layers of the multi-tiered top cladding layer 218. Non-limiting example of cladding material include oxide and/or dielectric such as SiO2. In some embodiments, the first layer of the multi-tiered top cladding layer 218 may be a metal layer. For example, a metal layer may be deposited and/or formed on the waveguide core layer 216 as described above and then cladding material deposited on the metal layer.

At step/operation 422, a thickness map of the top cladding layer 218 is generated. In an example embodiment, the thickness map is generated using a pattern recognition thickness metrology technique configured to measure film thickness at various locations. For example, the thickness map generated for the top cladding layer 218 may comprise thickness values across the top cladding layer 218. In some embodiments where the top cladding layer 218 comprises metal layers, the pattern recognition metrology may be configured to navigate around the metal layers embedded in the top cladding layer 218 to measure the thicknesses across the top cladding layer 218.

At step/operation 424, the top cladding layer 218 is trimmed to correct thickness errors in the top cladding layer 218 using one or more polishing techniques and based on the thickness map for the top cladding layer 218. For example, thickness trimming may be performed on the top cladding layer to reduce thickness variation in the top cladding layer 218. In various embodiments, the thickness trimming is performed on the top cladding layer 218 based on the thickness map for the top cladding layer 218 and using thickness trimming. For example, ion beam trimming may be performed where focused ion beam is rastered across the top cladding layer 218 and an amount of material is removed from one or more locations on the top cladding layer 218 based on the thickness at the respective locations. For example, in various embodiments, a focused ion beam is rastered across the top cladding layer 218, and the dwelling time for removing (e.g., milling away) material at a particular location is determined based on the thickness at that particular location as indicated in the thickness map for the top cladding layer 218.

In an example embodiment, the top cladding layer 218 is polished to, for example, planarize the top cladding layer 218. For example, CMP and/or other polishing techniques may be applied to the top cladding layer 218. For example, CMP and/or other polishing techniques may be applied to the top cladding layer 218 prior to applying thickness trimming (e.g., ion beam trimming and/or the like) to the top cladding layer 218. CMP and/or other polishing techniques may be applied to the top cladding layer 218 prior to applying thickness trimming to the top cladding layer 218.

In an example embodiment, each non-metal layer (e.g., cladding layer) of a multi-tiered top cladding layer 218 may be trimmed based on a thickness map for the respective layer and using thickness trimming, as described herein. Alternatively, or additionally, CMP and/or other polishing techniques may be applied to a respective non-metal layer prior to applying thickness trimming.

In an example embodiment, the metal layers embedded in a multi-layered top cladding layer 218 comprising such metal layers may be trimmed to correct thickness in the metal layers using one or more polishing techniques and based on the thickness map of the metal layer. For example, thickness trimming may be performed on the metal layers to reduce thickness variation in the metal layers. In an example embodiment, each metal layer is trimmed using thickness trimming and based on the thickness map for the respective metal layer prior to depositing cladding material on the respective metal layer.

At step/operation 426, the top cladding layer 218 is etched and/or patterned. For example, the top cladding layer 218 may be etched to form one or more vias in an example embodiment. In some embodiments, the top cladding layers 218 includes a plurality of metal layers. In some embodiments, thickness trimming may be applied to the plurality of metal layers.

In some embodiments, the waveguide core layer 216 and/or the top cladding layer 218 may not be trimmed (e.g., thickness trimming may not be applied to the waveguide core layer 216 and/or the top cladding layer 218). For example, thickness trimming may be applied to the bottom cladding layer 214 while thickness trimming may not be applied to the waveguide core layer 216 and/or the top cladding layer 218. In some embodiments, the photonic-integrated confinement apparatus 212 may not include metal layers below the waveguide core layer 216. In such some embodiments, the bottom cladding layer 214 may be trimmed (e.g., thickness trimming applied) while thickness trimming is not applied to the waveguide core layer 216 and/or the bottom cladding layer 214.

### Technical Advantages

Various embodiments provide technical solutions to the technical problems associated with integrated photonics. In various embodiments, apparatuses, systems, and methods provide for applying one or more trimming operations to layer(s) of a confinement apparatus to correct thickness errors based on the thickness map(s) of the layer(s). In various embodiments, a pattern recognition thickness metrology technique is leveraged to generate the thickness map for one or more layers (e.g., waveguide core layer, top cladding layer above the waveguide core layer, bottom cladding layer below the waveguide core layer, metal layer trimming, and/or the like). In various embodiments, a material agnostic trimming operation, for example, thickness trimming is applied to the one or more layers during fabrication of the confinement apparatus to trim the one or more layers such that desired target thickness and/or thickness uniformity is achieved. In various embodiments, a layer is trimmed using the thickness trimming to achieve desired target thickness and thickness uniformity.

By applying thickness trimming techniques that enables desired target thickness and thickness uniformity to be achieved, various embodiments of the present disclosure provide absolute thickness control. Additionally, various embodiments of the present disclosure enable tighter within wafer thickness uniformity, which in turn enables die-to-die and zone-zone consistency, for example, for design validation and ion trap yield.

### Exemplary Controller

In various embodiments, a photonic-integrated confinement apparatus system 200 is incorporated into a system (e.g., a quantum computer 110) comprising a controller 30. In various embodiments, the controller 30 is configured to control various elements of the system (e.g., quantum computer 110). For example, the controller 30 may be configured to control the voltage sources 50, a cryogenic system and/or vacuum system controlling the temperature and pressure within the cryogenic and/or vacuum chamber 40, manipulation sources, cooling system, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more quantum objects confined by the photonic-integrated confinement apparatus system 200. In various embodiments, the controller 30 may be configured to receive signals from one or more photodetectors.

In various embodiments, a controller 30 may be configured to cause a quantum computer 110 to perform various operations (e.g., computing operations such as gate operations, cooling operations, transport operations, qubit interaction operations, qubit measurement operations, leakage suppression operations, and/or the like). For example, the controller 30 may be configured to cause manipulation sources to provide manipulation signals to atomic objects confined and/or trapped within photonic-integrated confinement apparatus 212. For example, the controller 30 may be configured to cause the laser system, possibly in coordination with servo system, to provide one or more gate signals to one or more atomic objects confined and/or trapped within the photonic-integrated confinement apparatus 212 so as to enact, for example, one or more quantum gates. In various embodiments, the controller 30 may be configured to control a cryogenic system and/or vacuum system controlling the temperature and pressure within the cryogenic and/or vacuum chamber 40, manipulation sources, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more atomic objects within the atomic object confinement apparatus.

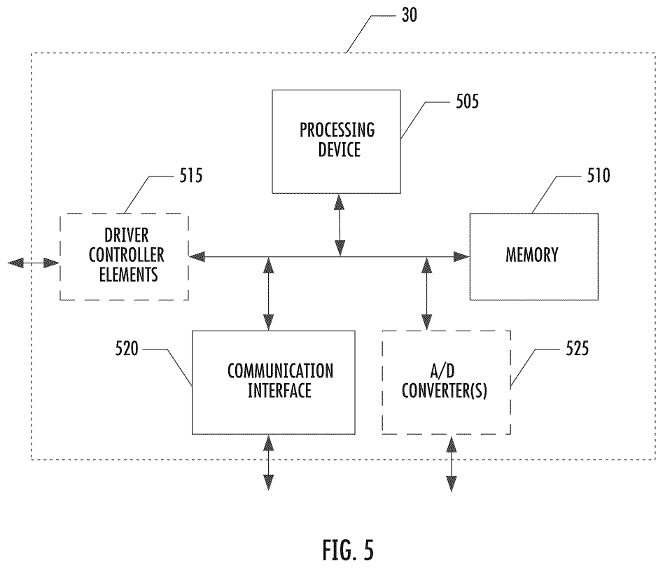

As shown in FIG. 5, in various embodiments, the controller 30 may comprise various controller elements including processing element(s) 505, memory 510, driver controller elements 515, a communication interface 520, analog-digital converter 525, and/or the like. For example, the processing element(s) 505 may comprise programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like, and/or controllers. The term circuitry may refer to an entirely hardware embodiment or a combination of hardware and computer program products. In an example embodiment, the processing clement(s) 505 of the controller 30 comprises a clock and/or is in communication with a clock.

For example, the memory 510 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 510 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 510 (e.g., by a processing element(s) 505) causes the controller 30 to perform one or more steps, operations, processes, procedures and/or the like described herein for tracking the phase of an atomic object within an atomic system and causing the adjustment of the phase of one or more manipulation sources and/or signal(s) generated thereby.

In various embodiments, the driver controller elements 515 may include one or more drivers and/or controller elements each configured to control one or more drivers. In various embodiments, the driver controller elements 515 may comprise drivers and/or driver controllers. For example, the driver controllers may be configured to cause one or more corresponding drivers to be operated in accordance with executable instructions, commands, and/or the like scheduled and executed by the controller 30 (e.g., by the processing element(s) 505). In various embodiments, the driver controller elements 515 may enable the controller 30 to operate a laser system, servo, manipulation sources, vacuum and/or cryogenic systems, and/or the like. In various embodiments, the drivers may be laser drivers; microwave drivers; vacuum component drivers; cryogenic and/or vacuum system component drivers; current drivers, and/or the like. For example, the drivers and/or driver controllers may be configured to cause a magnetic field generation device (e.g., comprising circuitry coupled to a voltage source (e.g., a current driver or voltage driver), permanent magnet(s), and/or a combination thereof) to generate a magnetic field having a particular direction and magnitude at one or more positions of the photonic-integrated confinement apparatus 212. In various embodiments, a plurality of positions of the photonic-integrated confinement apparatus 212 (e.g., atomic object confinement apparatus zones) may be defined. In various embodiments, the controller 30 comprises means for communicating and/or receiving signals from one or more optical receiver components such as cameras, MEMs cameras, CCD cameras, photodiodes, photomultiplier tubes, and/or the like. For example, the controller 30 may comprise one or more analog-digital converter element(s) 525 configured to receive signals from one or more optical receiver components, calibration sensors, and/or the like.

In various embodiments, the controller 30 may comprise a communication interface 520 for interfacing and/or communicating with a computing entity 10. For example, the controller 30 may comprise a communication interface 520 for receiving executable instructions, command sets, and/or the like from the computing entity 10 and providing output received from the quantum computer 110 (e.g., from an optical collection system) and/or the result of a processing the output to the computing entity 10. In various embodiments, the computing entity 10 and the controller 30 may communicate via a direct wired and/or wireless connection and/or one or more wired and/or wireless networks 20.

### Exemplary Computing Entity

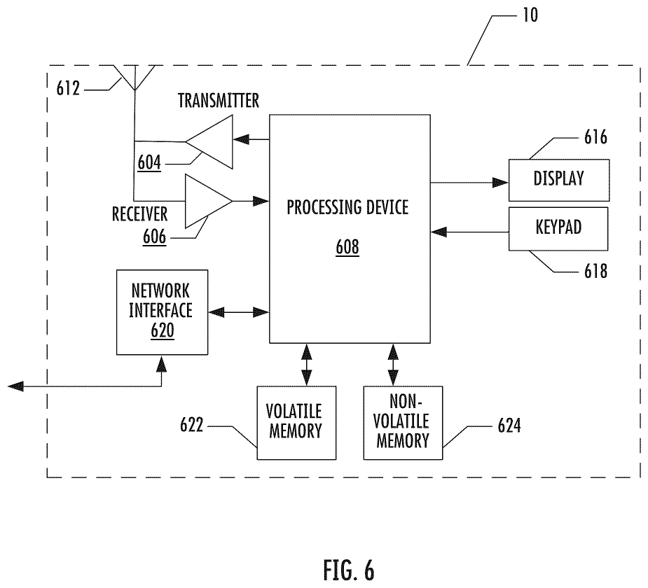

FIG. 6 provides an illustrative schematic diagram of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110. For example, a user may operate a computing entity 10 to generate and/or program a quantum algorithm and/or quantum circuit (e.g., that includes a D-state AC-Stark shift gate) that may be provided such that the controller 30 may receive the quantum algorithm and/or quantum circuit and cause the quantum computer 110 to perform the quantum algorithm and/or quantum circuit.

As shown in FIG. 6, a computing entity 10 can include an antenna 612, a transmitter 604 (e.g., radio), a receiver 606 (e.g., radio), and a processing element 608 that provides signals to and receives signals from the transmitter 604 and receiver 606, respectively, which may collectively be referred to a transceiver. The signals provided to and received from the transmitter 604 and the receiver 606, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

The computing entity 10 may comprise a network interface 620 and also comprise a user interface device comprising one or more user input/output interfaces (e.g., a display 616 and/or speaker/speaker driver coupled to a processing element(s) 608 and a touch screen, keyboard, mouse, and/or microphone coupled to a processing element(s) 608). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 618 (hard or soft), a touch display, voice/speech or motion interfaces, scanners, readers, or other input device. In embodiments including a keypad 618, the keypad 618 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile memory or storage 622 and/or non-volatile memory or storage 624, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein. they are used in a generic and descriptive sense only and not for purposes of limitation.

What is claimed is:

1. A method of controlling film thickness of a photonic-integrated confinement apparatus, the method comprising:
depositing a bottom cladding layer on a substrate;
generating a thickness map of the bottom cladding layer;
performing thickness trimming on the bottom cladding layer based on the thickness map for the bottom cladding layer, to achieve desired target thickness and thickness uniformity;
depositing a waveguide core layer on the bottom cladding layer;
generating a thickness map of the waveguide core layer;
performing thickness trimming on the waveguide core layer based on the thickness map for the waveguide core layer, to achieve desired target thickness and thickness uniformity;
depositing a top cladding layer on the waveguide core layer;
generating a thickness map of the top cladding layer; and
performing thickness trimming on the top cladding layer based on the thickness map for the top cladding layer, to achieve desired target thickness and thickness uniformity.

2. The method of claim 1, wherein performing thickness trimming comprises performing one or more of ion beam trimming, fluid jet polishing, or magnetorheological polishing.

3. The method of claim 1, wherein the bottom cladding layer is planarized prior to performing thickness trimming on the bottom cladding layer and/or after performing thickness trimming on the bottom cladding layer.

4. The method of claim 3, wherein the bottom cladding layer is planarized by performing chemical mechanical polishing on the bottom cladding layer.

5. The method of claim 1, wherein the waveguide core layer is mechanically polished prior to performing thickness trimming on the waveguide core layer and/or after performing thickness trimming on the waveguide core layer.

6. The method of claim 1, wherein the top cladding layer is planarized prior to performing thickness trimming on the top cladding layer and/or after performing thickness trimming on the top cladding layer.

7. The method of claim 6, wherein the top cladding layer is planarized by performing chemical mechanical polishing operation on the top cladding layer.

8. The method of claim 1, further comprising patterning features within one or more of the bottom cladding layer or the top cladding layer, wherein the features comprise a plurality of metal layers.

9. The method of claim 8, further comprising performing thickness trimming on each metal layer of the plurality of metal layers based on a thickness map of the metal layer.

10. The method of claim 1, wherein the photonic-integrated confinement apparatus comprises a multi-layered ion trap.

11. A method of controlling film thickness of a photonic-integrated confinement apparatus, the method comprising:
depositing a bottom cladding layer on a substrate;
generating a thickness map of the bottom cladding layer;
performing thickness trimming on the bottom cladding layer based on the thickness map for the bottom cladding layer, to achieve desired target thickness and thickness uniformity;
depositing a waveguide core layer on the bottom cladding layer; and
depositing a top cladding layer on the waveguide core layer.

12. A photonic-integrated confinement apparatus comprising:
a bottom cladding layer formed on a substrate;
a waveguide core layer formed on the bottom cladding layer; and
a top cladding layer formed on the waveguide core layer; wherein thickness trimming was previously performed on one or more of the bottom cladding layer, the waveguide core layer, or the top cladding layer during fabrication of the photonic-integrated confinement apparatus, to achieve desired target thickness and thickness uniformity.

13. The photonic-integrated confinement apparatus of claim 12, wherein performing thickness trimming comprises performing one or more of ion beam trimming, fluid jet polishing, or magnetorheological polishing.

14. The photonic-integrated confinement apparatus of claim 12, wherein:
a plurality of metal layers are embedded within the bottom cladding layer and/or the top cladding layer; and
thickness trimming was previously performed on one or more of the plurality of metal layers during fabrication of the photonic-integrated confinement apparatus, to achieve desired thickness uniformity.

15. The photonic-integrated confinement apparatus of claim 12, wherein the photonic-integrated confinement apparatus comprises a multi-layered ion trap.

16. A photonic-integrated confinement apparatus system comprising:
a confinement apparatus chip comprising a photonic-integrated confinement apparatus having a bottom cladding layer, a waveguide core layer, and a top cladding layer thereon, wherein the waveguide core layer is sandwiched between the bottom cladding layer and the top cladding layer, and wherein thickness trimming was previously performed on one or more of the bottom cladding layer, the waveguide core layer, or the top cladding layer during fabrication, to achieve desired thickness uniformity.

17. The photonic-integrated confinement apparatus system of claim 16, wherein the photonic-integrated confinement apparatus system is configured for operation under cryogenic and/or vacuum conditions.

18. The photonic-integrated confinement apparatus system of claim 16, further comprising:
a bridge chip having at least one optical element disposed thereon or a delivery chip having at least one delivery optical element disposed thereon, wherein thickness trimming is previously performed on one or more layers of the bridge chip or the delivery chip, to achieve desired thickness uniformity.

19. The photonic-integrated confinement apparatus system of claim 16, wherein:
a plurality of metal layers are embedded within the bottom cladding layer; and
thickness trimming was previously performed on one or more of the plurality of metal layers during fabrication, to achieve desired thickness uniformity.

20. The photonic-integrated confinement apparatus system of claim 16, wherein the photonic-integrated confinement apparatus comprises a multi-layered ion trap.
